(19) United States
(12) Patent Application Publication
(10) Pub. No.: US 2008/0298050 A1
(43) Pub. Date: Dec. 4, 2008

(54) Elnore cup/Elnore ice

(76) Inventor: Moustafa Elnore, Linden, NJ (US)

Correspondence Address: Moustafa Elnore, 212 Arthur Street, Linden, NJ, 07036, US

(21) Appl. No.: 11/807,587

(22) Filed: May 30, 2007

(51) Int. Cl. F21V 33/00

(52) U.S. Cl. 362/154; 362/253

(57) ABSTRACT

El nore cup is modification of a regular glass cup been decorated with light.

El nore vase is modification of a regular glass vase been decorated with light and water pump to create fountain.

El nore ice is 1 inch plastic ball filled with dry ice (carbon dioxide) for decoration and advertising purpose to be used instead of regular ice cube.

### SUMMARY OF THE INVENTION

The foregoing abstract is not to be taken as limiting this invention in any way shape or form whatsoever.

El nore cup is the wide variety type of cups been decorated with penlight for romantic date or whatsoever.

El nore vase is colorful glass flower vase been decorated with light and water fountain the water in the vase mixed with perfume as air freshener, also the vase can be use as a night light inside or outside the house.

El nore ice will extend the life of the drink, deliver romantic massage and it will be used for advertising.

### BACK GROUND OF THE INVENTION

El nore cup will replace the romantic candles used in the date which is a fair and smoke hazard.

El nore vase will keep the flower fresh day and night.

El nore ice element the melting ice witch cause drink test change, more save for children how sallow the regular ice cube, save more room in the fridge, and easy to serve.

### ART OF THE INVENTION

El nore cup
1—It will open a wide variety of cup design.
2—Will create a new sign language in the restaurant and in the romantic date.

El nore vase
1—It will be used as night light in or outside of the house.
2—Change the color of the flower by changing the color of the lamp or light reflector.
3—The perfume in the water will work as air fresh moving through the fountain.
4—Keep the flower fresh and life day and night.
5—Open a wide variety of vase design.

El nore ice
1—More save for children and fun.
2—More romantic in the date.
3—It will be used for advertising.
4—It will extend the life of the drink.
5—It will not change the drink test.
6—Easy to serve, store in the welkin box in restaurant and it will save money.
7—Can be used moor then once and it will element the use of ice machine.

### THE DRAWING

FIG. 1 is a view of El nore cup

FIG. 1A is a cross sectional view of the part A in FIG. 1 shown electric structure.

FIG. 2 is a cross sectional view of anther kind of cups connected with plastic tray.

FIG. 2a a plan view of plastic tray.

FIG. 3 is a cross sectional view for different kind of drinking cup connected with plastic tray.

FIG. 3a a plan view of the electric plastic tray.

FIG. 4 is cross sectional view of a flower vase connected with plastic base.

FIG. 5 is a cross sectional view of a flower vase with a fluorescent donut lamp in bottom of the vase and water pump inside the vase working as fountain.

FIG. 6 is a cross sectional view of anther kind of flower vase the lamp been placed inside a groove under the vase.

FIG. 7 different types of El nore ice.

FIG. 7a Mickey Mouse face painted on the ball or placed inside the ball as a statue (model)

FIG. 7b is a view of El nore ice with a Mercedes Benz logo painted or placed inside the ball.

FIG. 7c is a view of El nore ice with a love heart logo painted or placed inside the ball.

FIG. 7d is a view of El nore ice with New York abbreviation logo.

FIG. 7e is a view of El nore ice with U.S.A. flag painted or placed inside the ball FIG. 7f is a view of El nore ice with different color circles painted on the ball or as a different color small balls inside the ice ball, all the object painted or placed inside the ball could be phosphoric.

FIG. 8 is a cross sectional view of El nore ice inside a drinking cup.

FIG. 9 is a cross sectional view of El nore ice inside a plastic bag.

### DETAILED DESCRIPTION

The forgoing description is not to be taken as limiting this invention in any way shape or form whatsoever.

No dimension will be mentioned in the detailed description of the invention as been mentioned the idea will open a wide variety of new designs depended on the culture of each country and the test of the designer

The following description of the preferred embodiment can best be understood by referring to the figures.

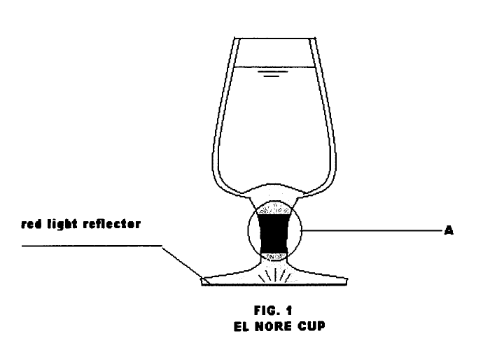

As been shown in FIG. 1 a pen light can be used in the drinking cup for romantic and decoration purpose the same as flash light structure using watch battery and pen light lamp build in drinking cup leg support we can use tow lamp one directed upward and other down word controlled by tow switches in the side of the plastic type, the lower lamp also can be reflect to the drink by a mirror light reflector under the cup, the ellipse shape glass will help distributed the light through the drink. The plastic type will be screw or squeezed to the leg sport.

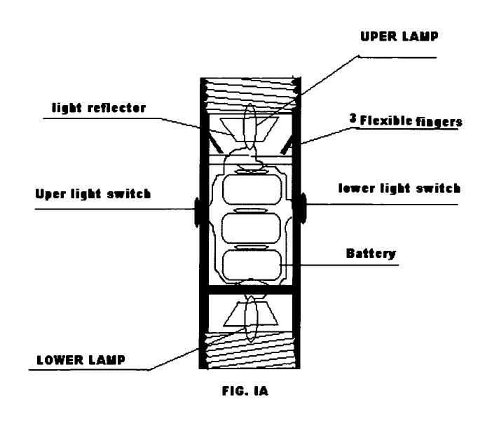

The light also can be placed under a regular cup as been shown in FIG. 2, FIG. 2a, FIG. 3 and FIG. 3a with plastic tray holding the battery, lamp and the switch, the plastic tray can be attached to the cup by so many ways like screw or squeezed to the cup base.

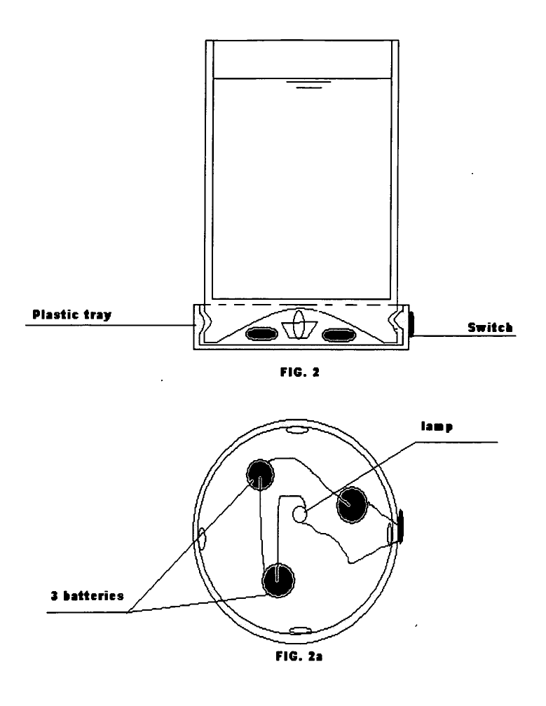

The same idea will apply to the flower vase as been shown in FIG. 4 the plastic base should have heat exits holes.

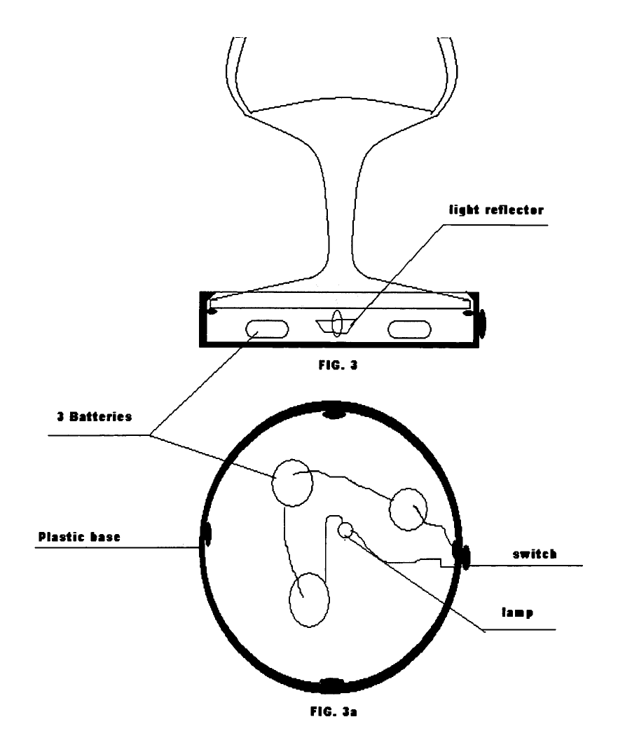

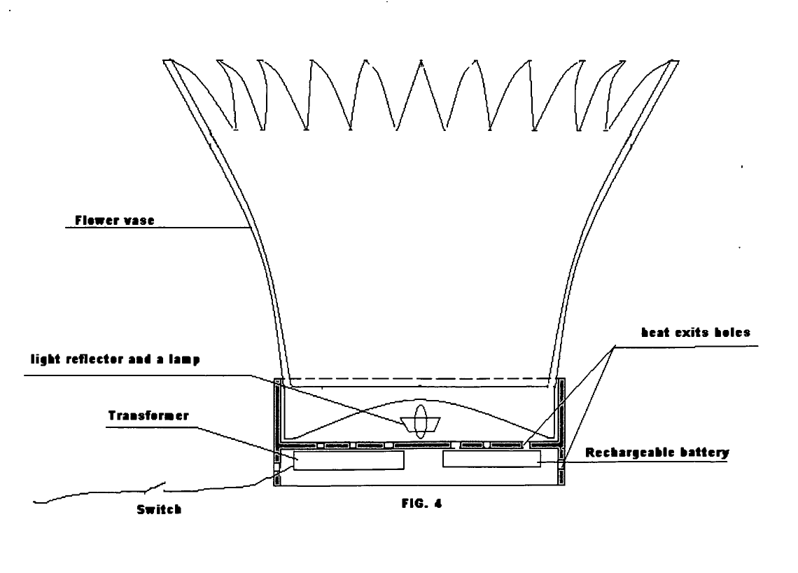

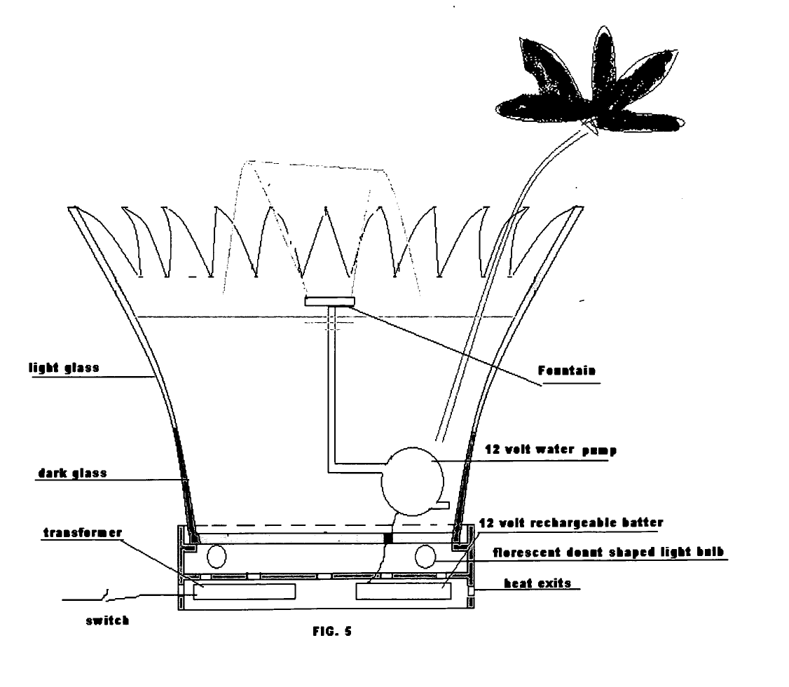

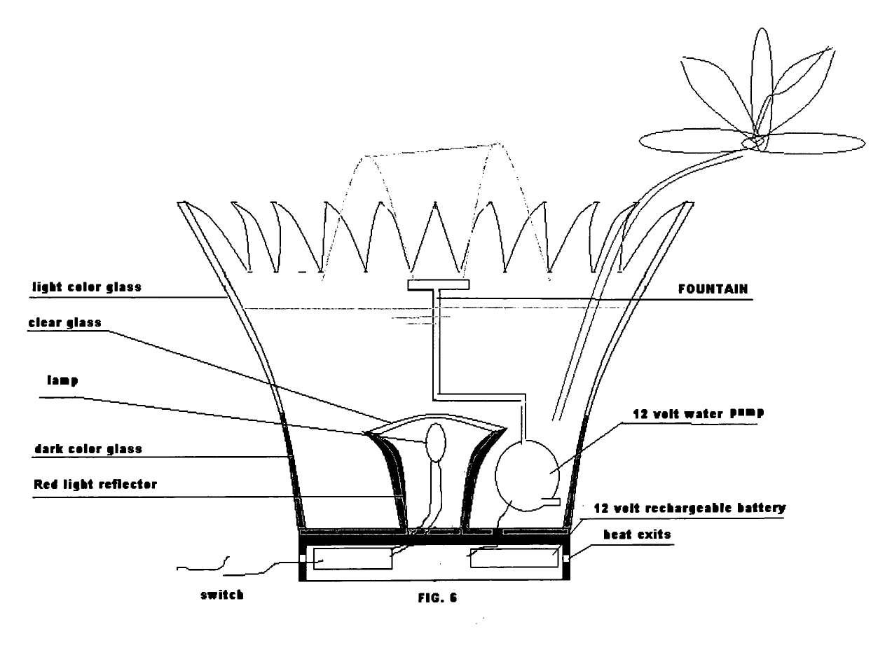

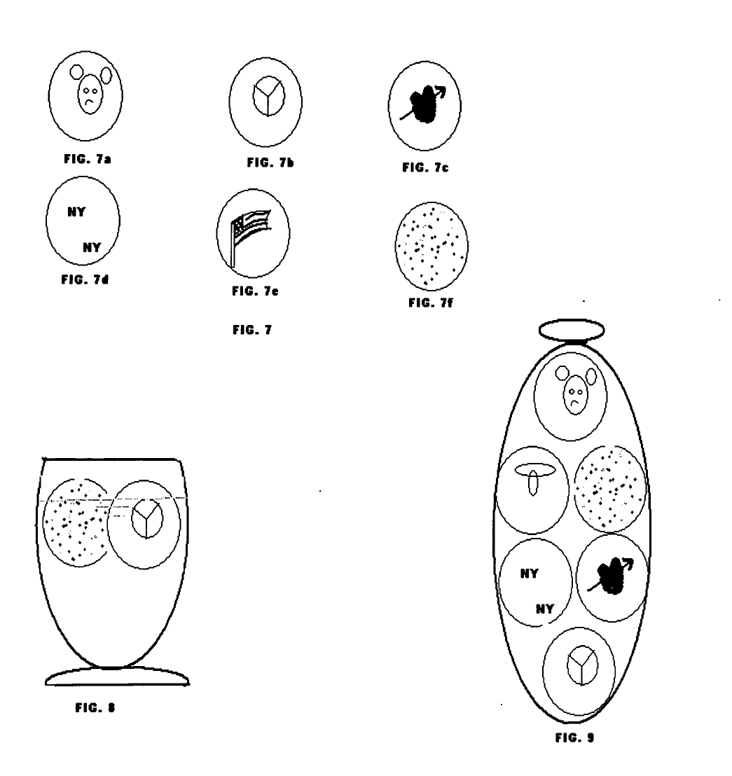

We also can add 12 volt water pump inside the vase to work as fountain, controlled by adjustable switch as been shown in FIG. 4 and FIG. 5, we also can use fluorescent donut lamp as in FIG. 5 and we can place the lamp inside the vase as in FIG. 6.

The color of the light can be changed by changing the lamp or the reflected mirror color.

El nore ice most is a minimum of 1 inch diameter for the safety of the children the object painted on the ball or placed inside the ball better to be light reflector so it can look nicer especially in El nore cup

I claim:

1. A pan light can be used in the drinking cup for decoration and for romantic dates.

2. A pan light or a regular light can be used in the flower vase for decoration and as a light night.

3. A water pump can be used inside the flower vase to work as fountain for decoration and as air freshener.

4. A dry ice (carbon dioxide) filled inside a clear plastic ball can be used to extend the life of the cold drink, advertising and not changing the test of the drink like ice cube.
